(19) United States
(12) Patent Application Publication
(10) Pub. No.: US 2023/0243547 A1
(43) Pub. Date: Aug. 3, 2023

(54) ENERGY RECOVERY VENTILLATION PANEL

(71) Applicants: Matthew Kirby Smith, Atlanta, GA (US); Cameron William Irvin, Atlanta, GA (US); Ecieño Anthony Carmona, Summerfield, FL (US)

(72) Inventors: Matthew Kirby Smith, Atlanta, GA (US); Cameron William Irvin, Atlanta, GA (US); Ecieño Anthony Carmona, Summerfield, FL (US)

(21) Appl. No.: 18/102,674

(22) Filed: Jan. 27, 2023

Related U.S. Application Data
(60) Provisional application No. 63/304,698, filed on Jan. 30, 2022.

(51) Int. Cl. F24F 12/00; F24F 13/30

(52) U.S. Cl. CPC F24F 12/006; F24F 13/30; F24F 2005/0064

(57) ABSTRACT

An energy recovery ventilation device includes a housing having a first side, a second side opposite the first side. The device also includes at least one first channel within the housing, and at least one second channel within the housing. The device includes a first inlet and a first outlet. The first inlet is fluidly coupled to the first outlet via the first channel. The device also includes a second inlet and a second outlet. The second inlet is fluidly coupled to the second outlet via the second channel. The device includes a first cover supported by the first side of the housing. The first cover is made of a first material. The device also includes a second cover supported by the second side of the housing. The second cover is made of a second material that is different than the first material.

### PRIORITY

This application claims priority to U.S. Provisional Patent Application Ser. No. 63/304,698, filed Jan. 30, 2022, which is hereby incorporated by reference in its entirety.

### BACKGROUND

An energy recovery ventilator is an air-to-air heat exchanger that may be used within a heating, ventilation, and air conditioning (HVAC) system to precondition (e.g., pre-cool or pre-heat) ventilation air (e.g., clean outside air) for a building with exhausted air (e.g., dirty inside air) from the building.

### SUMMARY

In one example, an energy recovery ventilation device includes a housing having a first side, a second side opposite the first side, a first end, and a second end opposite the second end. Each of the first end and the second end extends between the first side and the second side of the housing. The energy recovery ventilation device also includes at least one first channel within the housing. The at least one first channel extends between the first end and the second end of the housing. The energy recovery ventilation device includes at least one second channel within the housing. The at least one second channel extends between the first end and the second end of the housing. A second channel of the at least one second channel is separated from a first channel of the at least one first channel by an inner wall of the housing. The energy recovery ventilation device also includes a first inlet and a first outlet. The first inlet is fluidly coupled to the first outlet via the first channel. The energy recovery ventilation device includes a second inlet and a second outlet. The second inlet is fluidly coupled to the second outlet via the second channel. The energy recovery ventilation device also includes a first cover supported by the first side of the housing, and a second cover supported by the second side of the housing. The first cover is made of a first material, and the second cover is made of a second material. The second material is different than the first material.

In one example, the first material is transparent to solar radiation and is a thermal insulator, and the second material is a reflective material, has a normal reflectance of at least 90%, or is a reflective material and has a normal emittance of at least 90%.

In one example, the first material is an acrylic, a polycarbonate, or a glass. The second material is a reflective metal foil, and may include a coating of Silicon dioxide, boron nitride, barium sulfate, or any combination thereof, or is a metal foil and includes Silicon dioxide, boron nitride, barium sulfate, or any combination thereof.

In one example, the housing is a thermally conductive material.

In one example, a thickness of the inner wall of the housing is between 0.1 mm and 2.0 mm.

In one example, a thickness of the first channel, in a direction of the thickness of the inner wall of the housing, is between 2 mm and 100 mm. A thickness of the second channel, in the direction of the thickness of the inner wall of the housing, is between 2 mm and 100 mm.

In one example, a height of the first channel, in a direction perpendicular to the direction of the thickness of the inner wall of the housing, is between 10 mm and 200 mm. A height of the second channel, in the direction perpendicular to the direction of the thickness of the inner wall of the housing, is between 10 mm and 200 mm.

In one example, the first cover is removably attached to the first side of the housing, and the second cover is removably attached to the second side of the housing.

In one example, the housing is made of a material that reflects solar radiation.

In one example, the housing is made of a material with a high emissivity.

In one example, the housing is made of a combination of a thermally conductive material, a reflective material, and an emissive material.

In one example, the housing is made of a material with a high water vapor transmission rate.

In one example, the first inlet includes a first opening. The first opening extends from the second side of the housing, through the housing, and into the first channel. The first opening is adjacent to the first end of the housing. The first outlet includes a second opening. The second opening extends from the first side of the housing, through the housing, and into the first channel. The second opening is adjacent to the second end of the housing. The second inlet includes a third opening. The third opening extends from the second side of the housing, through the housing, and into the second channel. The third opening is adjacent to the second end of the housing. The second outlet includes a fourth opening. The fourth opening extends from the first side of the housing, through the housing, and into the second channel. The fourth opening is adjacent to the first end of the housing.

In one example, the energy recovery ventilation device is connectable to an air handling unit of a building, such that the first inlet is an intake air inlet, the first outlet is an intake air outlet, the second inlet is an exhaust air inlet, and the second outlet is an exhaust air outlet.

In one example, the inner wall is a first inner wall. Another first channel of the at least one first channel is separated from the second channel by a second inner wall of the housing. The second inner wall of the housing is opposite the first inner wall of the housing. Another second channel of the at least one second channel is separated from the other first channel by a third inner wall of the housing. The third inner wall of the housing is opposite the second inner wall of the housing.

In one example, the energy recovery ventilation device further includes a third inlet and a third outlet. The third inlet is fluidly coupled to the third outlet via the other first channel. The energy recovery ventilation device also includes a fourth inlet and a fourth outlet. The fourth inlet is fluidly coupled to the fourth outlet via the other second channel.

In one example, the third inlet includes a fifth opening. The fifth opening extends from the second side of the housing, through the housing, and into the other first channel. The fifth opening is adjacent to the first opening. The third outlet includes a sixth opening. The sixth opening extends from the first side of the housing, through the housing, and into the other first channel. The sixth opening is adjacent to the second opening. The fourth inlet includes a seventh opening. The seventh opening extends from the second side of the housing, through the housing, and into the other second channel. The seventh opening is adjacent to the third opening.

In one example, the energy recovery ventilation device further includes a first inlet duct interface supported by the second side of the housing, adjacent to the first end of the housing, a first outlet duct interface supported by the first side of the housing, adjacent to the second end of the housing, a second inlet duct interface supported by the second side of the housing, adjacent to the second end of the housing, and a second outlet duct interface supported by the first side of the housing, adjacent to the first end of the housing. The first inlet duct interface is fluidly coupled to the first outlet duct interface via the first opening, the first channel, and the second opening. The second inlet duct interface is fluidly coupled to the second outlet duct interface via the third opening, the second channel, and the fourth opening.

In one example, the first cover and the second cover are rectangular in shape.

In one example, an energy recovery ventilation panel includes a housing having a first side, a second side opposite the first side, a first end, and a second end opposite the second end. Each of the first end and the second end extends between the first side and the second side of the housing. The energy recovery ventilation panel also includes a counterflow heat exchanger supported within the housing. The counterflow heat exchanger includes a plurality of channels within the housing. The energy recovery ventilation panel includes a first inlet duct interface supported by the second side of the housing, adjacent to the first end of the housing, and a first outlet duct interface supported by the first side of the housing, adjacent to the second end of the housing. The first inlet duct interface is fluidly coupled to the first outlet duct interface via a first portion of channels of the plurality of channels. The energy recovery ventilation panel also includes a second inlet duct interface supported by the second side of the housing, adjacent to the second end of the housing, and a second outlet duct interface supported by the first side of the housing, adjacent to the first end of the housing. The second inlet duct interface is fluidly coupled to the second outlet duct interface via a second portion of channels of the plurality of channels. The second portion of channels are different than the first portion of channels. The energy recovery ventilation panel includes a first cover supported by the first side of the housing, and a second cover supported by the second side of the housing. The first cover is made of a first material, and the second cover is made of a second material. The first material is transparent to solar radiation and is a thermal insulator, and the second material is a reflective material, has a normal reflectance of at least 90%, or is a reflective material and has a normal emittance of at least 90%.

In one example, a waste heat recovery system includes a plurality of energy recovery ventilation panels fluidly coupleable to an exhaust duct and an intake duct. Each energy recovery ventilation panel of the plurality of energy recovery ventilation panels includes a housing having a first side, a second side opposite the first side, a first end, and a second end opposite the second end. Each of the first end and the second end extends between the first side and the second side of the housing. The respective energy recovery ventilation panel includes a counterflow heat exchanger supported within the housing. The counterflow heat exchanger includes channels extending between the first end and the second end within the housing. The respective energy recovery ventilation panel includes a first duct interface and a second duct interface supported by the housing. The first duct interface is adjacent to the first end of the housing, and the second duct interface is adjacent to the second end of the housing. The first duct interface is fluidly coupled to the second duct interface via a first portion of the channels. The respective energy recovery ventilation panel includes a third duct interface and a fourth duct interface supported by the housing. The third duct interface is adjacent to the second end of the housing, and the fourth duct interface is adjacent to the first end of the housing. The third duct interface is fluidly coupled to the fourth duct interface via a second portion of the channels. The second portion of the channels is different than the first portion of the channels. The respective energy recovery ventilation panel includes a first cover supported by the first side of the housing. The first cover is made of a first material. The respective energy recovery ventilation panel includes a second cover supported by the second side of the housing. The second cover is made of a second material. The second material is different than the first material.

In one example, the plurality of energy recovery ventilation panels include an array of energy recovery ventilation panels fluidly coupleable to the exhaust duct and the intake duct.

In one example, the first material is transparent to solar radiation and is a thermal insulator. The second material is a reflective material, has a normal reflectance of at least 90%, or is a reflective material and has a normal emittance of at least 90%.

In one example, a position of the respective energy recovery ventilation panel relative to the exhaust duct and the intake duct is changeable, such that in a first configuration: the first duct interface and the second duct interface are intake interfaces, and the first duct interface is fluidly coupled to the intake duct via the first portion of the channels and the second duct interface; the third duct interface and the fourth duct interface are exhaust interfaces, and the fourth duct interface is fluidly coupled to the exhaust inlet duct via the second portion of the channels and the third duct interface; and the first cover faces a first direction. The position of the respective energy recovery ventilation panel relative to the exhaust inlet duct and the intake outlet duct is changeable, such that in a second configuration: the third duct interface and the fourth duct interface are intake interfaces, and the fourth duct interface is fluidly coupled to the intake duct via the second portion of the channels and the third duct interface; the first duct interface and the second duct interface are exhaust interfaces, and the first duct interface is fluidly coupled to the exhaust duct via the first portion of the channels and the second duct interface; and the second cover faces the first direction.

### BRIEF DESCRIPTION OF THE DRAWINGS

FIG. 1 is a first isometric view of an embodiment of an energy recovery ventilation panel;

FIG. 2 is a second isometric view of the energy recovery ventilation panel of FIG. 1;

FIG. 3 is a side view of the energy recovery ventilation panel of FIG. 1;

FIG. 4 is a cross-sectional view of another embodiment of an energy recovery ventilation panel;

FIG. 5 is an isometric view of yet another embodiment of an energy recovery ventilation panel;

FIG. 6 is an isometric view of an embodiment of an energy recovery ventilation panel connected to an intake duct and an exhaust duct; and

FIG. 7 is an exemplary plot of a temperature of clean air into a building after passing through an energy recovery ventilation panel of the present embodiments versus time.

### DETAILED DESCRIPTION

An energy recovery ventilation (ERV) panel that recovers both heat and moisture from an exhaust airstream of a building is provided. Covers made of different materials are attached to opposite sides of the ERV panel to provide energy boosts for different seasons (e.g., ambient temperatures) in which the ERV panel is used.

The ERV panel of the present embodiments combines energy recovery ventilation with solar absorption, reflection, and radiative cooling. The ERV panel is reversible depending on the season, such that solar absorption, or reflection and/or radiative cooling may be provided depending on the season. An array of the ERV panels may be directly connected to an air handling unit of a building without the need for additional fans or controls.

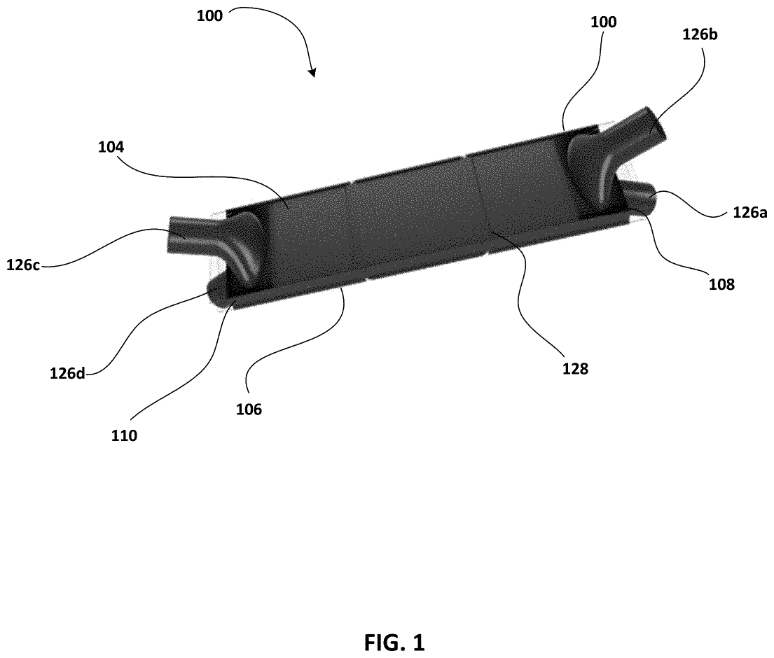

Referring to FIGS. 1-3, an embodiment of a thermal management device 100 for a building is provided. The thermal management device 100 is, for example, an energy recovery ventilation (ERV) panel (e.g., with an added energy boost from solar isolation (cold months) and thermal radiation (cold months)). The ERV panel 100 is configured to recover both heat and moisture from an exhaust airstream of a building.

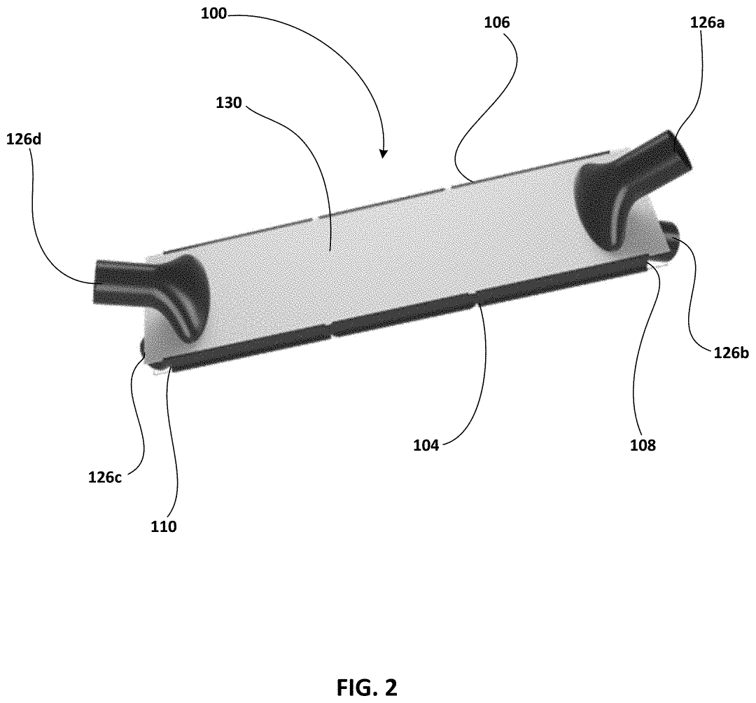

The ERV panel 100 includes a housing 102. The housing 102 has a first side 104 (see FIG. 1) and a second side 106 (see FIG. 2) opposite the first side 104. The housing 102 also has a first end 108 and a second end 110. The second end 110 is opposite the first end 108. The housing 102 of the ERV panel 100 may be any number of shapes and/or sizes. For example, as shown in the example of FIGS. 1-3, the housing 100 may be rectangular in shape.

In other embodiments, the housing 102 may be shaped differently than shown in the example of FIGS. 1-3. For example, in another embodiment, the housing 102 may be cylindrical in shape. In such an embodiment, the first side 104 and the second side 106 of the housing 102 may be formed by curved surfaces of semi-cylinders forming the overall cylindrical shape. Other shapes may be provided.

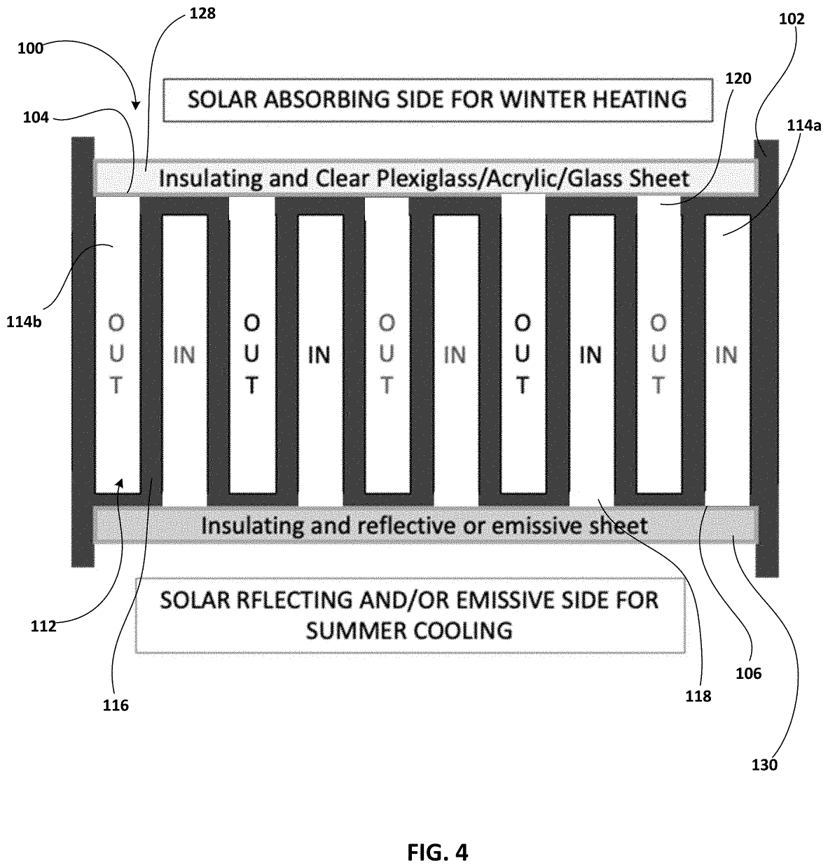

Referring to FIG. 4, the housing 102 supports (e.g., houses) a counter-flow heat exchanger 112 within the housing 102. The counter-flow heat exchanger 112 includes a plurality of channels 114 (e.g., tubular channels, passages) that extend between the first end 108 and the second end 110 of the housing 102. In one embodiment, the plurality of channels 114 are C-shaped channels at corresponding inlets and outlets, respectively, but tubular channels or passages between the corresponding inlets and outlets, respectively. The plurality of channels 114 extend from a position adjacent to the first end 108 of the housing 102 (e.g., offset relative to the first end 108 of the housing 102 by a thickness of the housing 102 at the first end 108) to a position adjacent to the second end 110 of the housing 102 (e.g., offset relative to the second end 110 of the housing 102 by a thickness of the housing 102 at the second end 110 of the housing 102).

The plurality of channels 114 may be any number of different shapes. For example, the plurality of channels 114 may be rectangular in shape, though other shapes may be provided. For example, the plurality of channels 114 may be cylindrical in shape (e.g., with a circular cross-section).

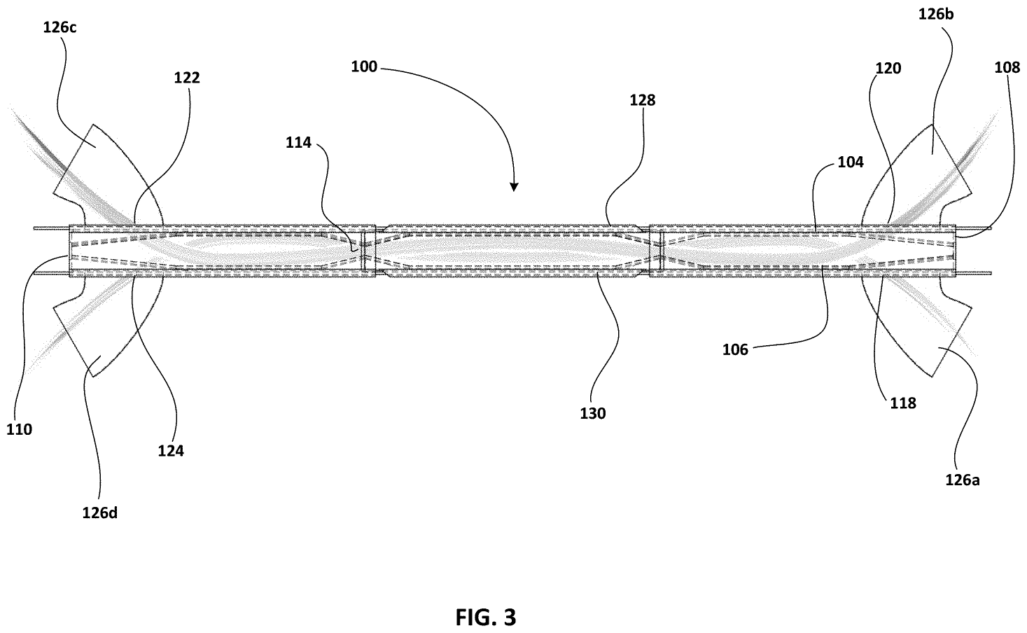

The plurality of channels 114 may be any number of sizes. For example, each channel of the plurality of channels 114 may have a thickness or width (e.g., in a direction parallel to the first side 104 and/or the second side 106) between 2 mm and 100 mm, and a height (e.g., in a direction perpendicular to the first side 104 and/or the second side 106) between 10 mm and 200 mm. The height of the plurality of channels 114 may approximately correspond to a thickness of the ERV panel 100. Other sizes may be provided. Referring to the example of FIG. 3, in one embodiment, the height of the plurality of channels 114 may vary along a length of the ERV panel 100 to control airflow through the plurality of channels 114.

In one embodiment, all channels of the plurality of channels 114 are a same size and a same shape. In another embodiment, subsets of channels of the plurality of channels 114 have different shapes and/or sides.

Each set of adjacent channels of the plurality of channels 114 is separated by a wall 116 (e.g., an inner wall of the housing 102). The inner walls 116 may be any number of shapes (e.g., rectangular) and/or sizes. The thinner the inner walls 116, the greater the efficiency of the heat exchanger 112. The higher the thermal conductivity and water vapor transfer rate of the wall material, the higher the efficiency of the heat exchanger 112. In one embodiment, a thickness (e.g., in the direction parallel to the first side 104 and/or the second side 106 of the housing 102) of the inner walls 116 is between 0.1 mm and 2.0 mm. In other embodiments, other thickness and/or other dimensions of the inner walls 116 may be provided.

inlets and outlets within the housing 102 are configured such that supply air and exhaust air flowing through the heat exchanger 112 do not mix. For example, the plurality of channels 114 include a first subset of channels (e.g., first channels 114a) and a second subset of channels (e.g., second channels 114b). In the configuration of the ERV panel 100 shown in FIG. 4 (e.g., orientation of the ERV panel 100 and fluid coupling between the ERV panel 100 and ducts from and to the building, respectively), supply air (e.g., clean air) flows through the first channels 114a, and exhaust air (e.g., dirty air) flows through the second channels 114b. The supply air flows through the first channels 114a (e.g., into the page of FIG. 4) in a different direction (e.g., opposite direction) compared to how the exhaust air flows through the second channels 114b (e.g., out of the page in FIG. 4).

Inlets and outlets may be formed in the housing 102 to control airflow within the first channels 114a and the second channels 114b (e.g., prevent mixing of the supply air and the exhaust air). FIG. 4 is a cross-section of the ERV panel 100 adjacent to the first end 108 of the housing 102. As shown in the example of FIG. 4, the second side 106 of the housing 102 includes openings 118 (e.g., first openings) extending from the second side 106 of the housing 102, through the housing 102, and into the first channels 114a, respectively. The supply air is able to enter the first channels 114a via the first openings 118. The housing 102 covers the second channels 114b at the second side 106 of the housing 102, at and adjacent to the first end 108 of the housing 102.

The first openings 118 may be any number of shapes and/or sizes. For example, the first openings 118 may be rectangular in shape and may have a width (e.g., in a direction parallel to the first end 108 and/or the second end 110 of the housing 102) that is a same size as the thickness of the first channels 114a. In one embodiment, a length of the first openings 118 is less than one quarter a length of the ERV panel 100. Each of the first openings 118 may have a same width and/or length. In one embodiment, at least some of the first openings 118 have different widths, lengths, and/or one or more other dimensions.

The first side 104 of the housing 102 includes openings 120 (e.g., second openings) extending from the first side 104 of the housing 102, through the housing 102, and into the second channels 114b, respectively. The exhaust air is able to exit the second channels 114b via the second openings 120. The housing 102 covers the first channels 114a at the first side 104 of the housing 102, at and adjacent to the first end 108 of the housing 102.

The second openings 120 may be any number of shapes and/or sizes. For example, the second openings 120 may be rectangular in shape and may have a width (e.g., in a direction parallel to the first end 108 and/or the second end 110 of the housing 102) that is a same size as the thickness of the second channels 114b. In one embodiment, a length of the openings 120 is less than one quarter a length of the ERV panel 100. Each of the second openings 120 may have a same width and/or length. In one embodiment, at least some of the second openings 120 have different widths, lengths, and/or one or more other dimensions.

The housing 102 includes similar openings at and/or adjacent to the second end 110 of the housing 102. For example, referring to FIG. 3, the first side 104 of the housing 102 includes openings 122 (e.g., third openings) extending from the first side 104 of the housing 102 and through the housing 102. Depending on the embodiment, the third openings 122 extend into the first channels 114a or the second channels 114b, respectively. For example, in the configuration shown in FIG. 3, the exhaust air is able to enter the second channels 114b via the third openings 122. In the example shown in FIG. 3, the housing 102 covers the first channels 114a at the first side 104 of the housing 102, at and adjacent to the second end 110 of the housing 102. In one embodiment, the housing 102 covers the second channels 114b at the first side 104 of the housing 102, at and adjacent to the second end 110 of the housing 102, and the third openings 122 extend into the first channels 114a. The supply air is thus able to exit the first channels 114a via the third openings 122 in such an embodiment.

The third openings 122 may be any number of shapes and/or sizes. For example, the third openings 122 may be rectangular in shape and may have a width (e.g., in a direction parallel to the first end 108 and/or the second end 110 of the housing 102) that is a same size as the thickness of the first channels 114a and/or the second channels 114b. In one embodiment, a length of the third openings 122 is less than one quarter a length of the ERV panel 100. Each of the third openings 122 may have a same width and/or length. In one embodiment, at least some of the third openings 122 have different widths, lengths, and/or one or more other dimensions.

The second side 106 of the housing 102 includes openings 124 (e.g., fourth openings) extending from the second side 106 of the housing 102 and through the housing 102. Depending on the embodiment, the fourth openings 124 extend into the first channels 114a or the second channels 114b, respectively. For example, in the configuration shown in FIG. 3, the supply air is able to exit the first channels 114a via the fourth openings 124. In the example shown in FIG. 3, the housing 102 covers the second channels 114b at the second side 106 of the housing 102, at and adjacent to the second end 110 of the housing 102. In one embodiment, the housing 102 covers the first channels 114a at the second side 106 of the housing 102, at and adjacent to the second end 110 of the housing 102, and the fourth openings 124 extend into the second channels 114b. The exhaust air is thus able to enter the second channels 114b via the fourth openings 124 in such an embodiment.

The fourth openings 124 may be any number of shapes and/or sizes. For example, the fourth openings 124 may be rectangular in shape and may have a width (e.g., in a direction parallel to the first end 108 and/or the second end 110 of the housing 102) that is a same size as the thickness of the first channels 114a and/or the second channels 114b. In one embodiment, a length of the fourth openings 124 is less than one quarter a length of the ERV panel 100. Each of the fourth openings 124 may have a same width and/or length. In one embodiment, at least some of the fourth openings 124 have different widths, lengths, and/or one or more other dimensions.

Referring to FIG. 3, in the configuration of the ERV panel 100 shown, the exhaust air enters the ERV panel 100 via the third openings 122 through the housing 102 at and/or adjacent to the second end 110 of the housing 102, flows through the second channels 114b within the housing 102, and exits the ERV panel 100 via the second openings 120 through the housing 102 at and/or adjacent to the first end 108 of the housing 102. The supply air enters the ERV panel 100 via the first openings 118 through the housing 102 at and/or adjacent to the first end 108 of the housing 102, flows through the first channels 114a within the housing 102, and exits the ERV panel 100 via the fourth openings 124 through the housing 102 at and/or adjacent to the second end 110 of the housing 102.

Referring to FIGS. 1-3, the ERV panel 100 may also include duct interfaces 126 at and/or adjacent to the first openings 118, the second openings 120, the third openings 122, and/or the fourth openings 124, respectively. For example, a first duct interface 126a may be supported by the second side 106 of the housing 102 at and/or adjacent to the first openings 118, and the first duct interface 126a may be fluidly coupled to the first channels 114a via the first openings 118. A second duct interface 126b may be supported by the first side 104 of the housing 102 at and/or adjacent to the second openings 120, and the second duct interface 126b may be fluidly coupled to the second channels 114b via the second openings 120. A third duct interface 126c may be supported by the first side 104 of the housing 102 at and/or adjacent to the third openings 122, and the third duct interface 126c may be fluidly coupled to the second channels 114b via the third openings 122. A fourth duct interface 126d may be supported by the second side 106 of the housing 102 at and/or adjacent to the fourth openings 124, and the fourth duct interface 126d may be fluidly coupled to the first channels 114a via the fourth openings 124.

The duct interfaces 126 may take any number of different forms. For example, the duct interfaces 126 may include a round duct interface, a round elbow (e.g., adjustable elbow), flanges disposed around the openings 118-124, respectively, and/or other interfaces. In one embodiment, the duct interfaces 126 only include the openings 118-124 and do not include any additional parts extending away from the housing 102.

The housing 102 may be made of any number of materials in any number of ways. For example, the housing 102 may be three-dimensionally (3D) printed with a material that is thermally conductive and may absorb/transmit moisture. The housing 102 may be printed with materials that absorb or reflect solar insolation. The housing 102 may be printed in materials with high emissivity and solar reflectivity. In one embodiment, the housing 102 is 3D printed with Ice9™ material from TCPoly, Inc. of Atlanta, Ga. The Ice9™ material is thermally conductive (e.g., greater than 1 W/m−K) and has a high solar absorptivity (e.g., greater than 0.8) that may result in greater than 800 W/m² solar thermal heat generation. In other embodiments, the housing 102 is made of other materials and/or is manufactured in a different way (e.g., not 3D printed).

Heat is exchanged (e.g., via convection and conduction) between the exhaust air and the supply air moving through the ERV panel 100 in opposite directions. Depending on an outside ambient temperature, the exhaust air may heat up or cool down the supply air before the supply air reaches an air handling unit of an HVAC system for a building to be heated or cooled. Moisture is transferred through the inner walls 116 through selectivity water vapor transmission due to a partial pressure difference between the fluid streams.

The first side 104 and the second side 106 of the housing 102 may support plates of different materials, respectively, to provide additional heating or cooling of the supply air. For example, referring to FIGS. 1-4, the first side 104 of the housing 102 supports one or more layers (e.g., a sheet) of a first material 128 (e.g., a first cover), and the second side 106 of the housing 102 supports one or more layers (e.g., a sheet) 130 of a second material (e.g., a second cover).

The first material of the first cover 128 may be any number of materials. For example, the first material may be a material that is transparent (e.g., solar transparency above 0.95) and thermally insulating (e.g., less than 1 W/m−k thermal conductivity). In one embodiment, the first material is a composition including acrylic, polycarbonate, glass, another material, or any combination thereof. The housing 102 may be made of a material with high solar absorptivity (e.g., resulting in greater than 70% solar thermal heat generation from incoming solar radiation), and this combined with the fact the first cover 128 is transparent and thermally insulating provides that solar energy may be transferred to the first side 104 of the housing 102 and allowed to transfer from the first side 104 of the housing 102 to the rest of the housing 102 (e.g., via conduction). The first material may be other materials.

In one embodiment, the first material of the first cover 128 may have a high solar absorptivity. With a first cover 128 having high solar absorbance, the housing 102 may not be made of a material with high solar absorptivity.

The first cover 128 may be attached to the first side 104 of the housing 102 in any number of ways. For example, the first cover 128 is attached to the first side 104 of the housing 102 with an adhesive and/or one or more connectors (e.g., one or more fasteners such as screws). In one embodiment, the first cover 128 is connected to the first side 104 of the housing 102 via slots extending along opposite sides of the first side 104 of the housing 102.

The second material of the second cover 130 may be any number of materials. For example, the second material may be a material that is reflective, or reflective and tuned to have high emissivity for radiative cooling. For example, the second material may be a metal foil and/or a film including Silicon dioxide, boron nitride, barium sulfate, another material, or any combination thereof. In one embodiment, the second material is a composition that has a high total solar reflectance (e.g., greater than 80% or 90%) but also has a high normal emittance (e.g., greater than 80%o or 90% in the sky window region of 8-13 μm wavelength). The composition of the second material may be tuned, such that an outer surface of the second cover 130 may have a radiative cooling power density of up to, for example, 120 W/m².

In one embodiment, the second cover 130 includes a reflective substrate or foil that may be coated with one or more emissive materials (e.g., Silicon dioxide, boron nitride, and/or barium sulfate), and particles of the one or more emissive materials may be encased in a polymer matrix such as a paint or a thin film. In another embodiment, the second material is a polymer composite that is both reflective and has high emissivity. To achieve radiative cooling, both high reflection and emission at particular wavelengths are to be provided. In one embodiment, a metal foil provides the reflection, and the particles encased in polymer provide proper emissive properties.

The second cover 130 may be attached to the second side 106 of the housing 102 in any number of ways. For example, the second cover 130 is attached to the second side 106 of the housing 102 with an adhesive and/or one or more connectors (e.g., one or more fasteners such as screws). In one embodiment, the second cover 130 is connected to the second side 106 of the housing 102 via slots extending along opposite sides of the second side 106 of the housing 102.

The ERV panel 100 may be positioned (e.g., relative to the sun) outside of a building based on the season and/or whether the building is to be heated or cooled. In other words, the ERV panel 100 may be used year-round. In winter months, for example, when the building is to be heated and intake air is cold, the ERV panel 100 may be positioned, such that the first cover 128 faces the sun. Solar radiation passes through the first cover 128, and the housing 102 absorbs some of this solar radiation, increasing a temperature of the housing 102. This increased temperature of the housing 102 further heats the cold intake air flowing through the counter-flow heat exchanger 112 within the housing 102. The solar heating of the housing 102 during the winter months, when the intake air is to be heated up prior to reaching an air handling unit for the building to be heated, provides a thermal energy boost. Heat and moisture between the exhaust air and the intake air are transferred within the counter-flow heat exchanger 112 within the housing 102 to preheat the cold intake air (e.g., ambient air). In other words, cold, fresh outside air is pulled into the counter-flow heat exchanger 112 by the air handling unit of the building, and hot, dirty exhaust air is pushed into the counter-flow heat exchanger 112 by the air handling unit. Due to heat transfer within the counter-flow heat exchanger 112 within the housing 102, warm, fresh outside air is pulled into the building, and cool, dirty exhaust air is expelled to ambient. Moisture may also be transferred within the counter-flow heat exchanger 112, such that the fresh outside air being pulled into the building has moisture added or removed, depending on climate.

The summer months, for example, when the building is to be cooled and intake air is warm or hot and humid, the ERV panel 100 may be positioned, such that the second cover 130 faces the sun. Solar radiation is reflected off of the second cover 130, and the second cover 130 radiates heat away from the housing 102, decreasing a temperature of the housing 102. This decreased temperature of the housing 102 further cools the warm or hot intake air flowing through the counter-flow heat exchanger 112 within the housing 102. The radiative cooling of the housing 102 during the summer months further cools the intake air prior to reaching the air handling unit for the building to be cooled. Heat and moisture are transferred from the intake air to the exhaust air within the counter-flow heat exchanger 112 within the housing 102 to cool the warm or hot intake air (e.g., ambient air). In other words, hot, humid fresh outside air is pulled into the counter-flow heat exchanger 112 by the air handling unit of the building, and cool, dry, and dirty exhaust air is pushed into the counter-flow heat exchanger 112 by the air handling unit. Due to heat transfer within the counter-flow heat exchanger 112 within the housing 102, cool, fresh outside air is pulled into the building, and warm dirty exhaust air is expelled to ambient. Moisture may also be transferred within the counter-flow heat exchanger 112, such that the fresh outside air being pulled into the building is also dried out.

In one embodiment, the heat exchange efficiency of the ERV panel 100 may vary between 60% and 100%, and the moisture exchange efficiency of the ERV panel 100 may vary between 30% and 90%. The heat exchange efficiency and the moisture exchange efficiency may depend on solar radiation and ambient air temperature. A total energy recovery effectiveness of up to 95% may be provided under normal operation due to, for example, the 3D-printed counter-flow design of the counter-flow heat exchanger 112 within the housing 102 and the material of which the housing 102 is made. The efficiency may be above 100% under favorable environmental conditions due to solar heating or radiative cooling.

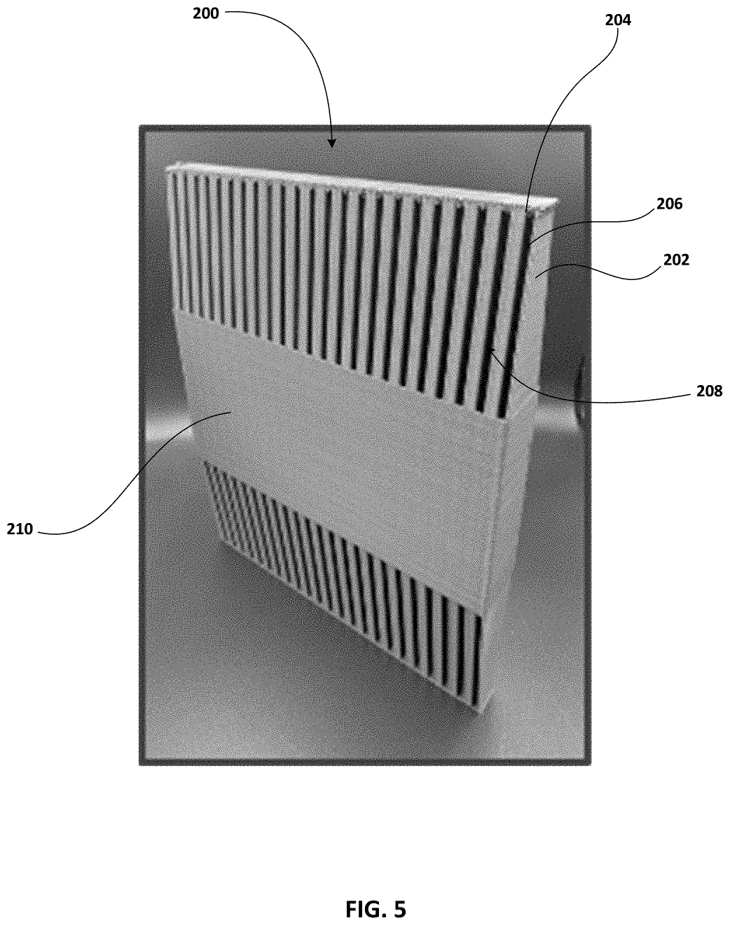

FIG. 5 shows another embodiment of an ERV panel 200. The ERV panel 200 includes similar components as the ERV panel 100. A housing 202 of the ERV panel 200, however, has a smaller length compared to the housing 102 of the ERV panel 100, and openings 204 through the housing 202 and into channels 206 of a cross-flow heat exchanger 208 within the housing 202 are longer (e.g., one-third the length of the housing 202 or more) compared to the openings 118-124 of the ERV panel 100. The longer openings 204 and the shorter length of the housing 202 compared to the housing 102 of the ERV panel 100 provides that a length of a cover 210 (e.g., to absorb heat from the sun) is also shorter compared to the first cover 128 and the second cover 130.

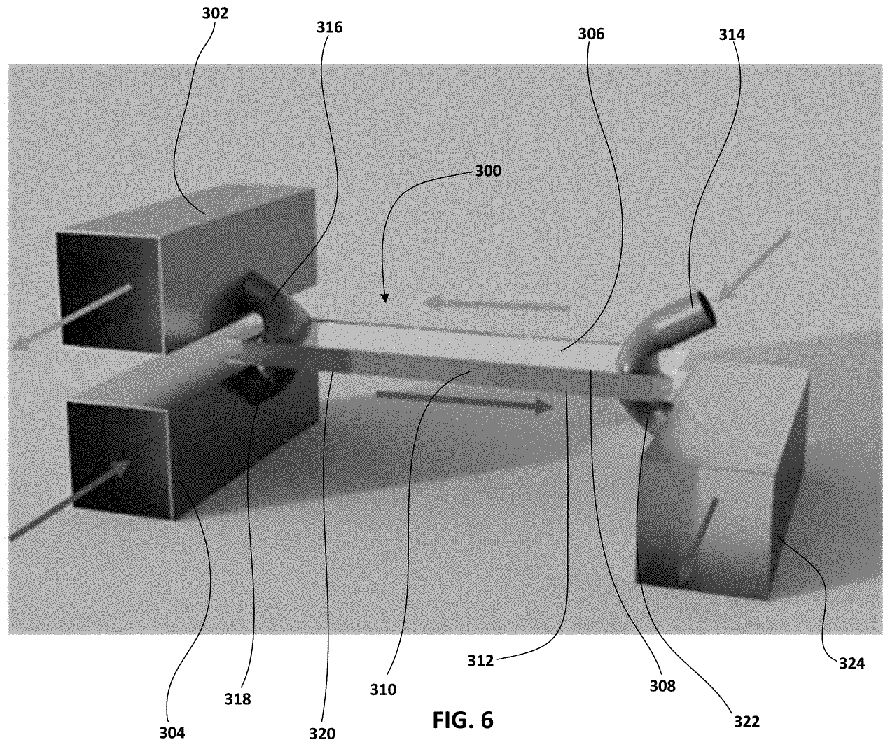

FIG. 6 illustrates an embodiment of an ERV panel 300 connected to an intake duct 302 and an exhaust duct 304. The ERV panel 300 is ducted directly into air handling units of a building via the intake duct 302 and the exhaust duct 304 without, for example, additional fans, controls, or ducting inside the building. In the embodiment shown in FIG. 6, a first cover 306 supported by a first side 308 of a housing 310 of the ERV panel 300 is facing in a direction towards the sun, and a second cover 312 is facing towards a surface (e.g., a roof of the building) supporting the energy recovery ventilation panel 300, the intake duct 302, and the exhaust duct 304. In the example shown, the first cover 306 is similar to the first cover 128 (e.g., thermally insulating and transparent), and the second cover 312 is similar to the second cover 130 (e.g., reflective and high thermal emissivity). The ERV panel 300 may be configured (e.g., positioned) as shown in FIG. 6 during, for example, the summer.

Cold, fresh outside air is pulled into first channels within the ERV panel 300 via a first duct interface 314 of the ERV panel 300 (e.g., at the first side 308 of the housing 310). Warmer, fresh outside air is pulled out of the first channels of the ERV panel 300 via a second duct interface 316 of the ERV panel 300 (e.g., at the first side 308 of the housing 310, opposite the first duct interface 314), and into the intake duct 302. Warm and dirty exhaust air is pushed into second channels within the ERV panel 300 via a third duct interface 318 of the ERV panel 300 (e.g., at a second side 320 of the housing 310 opposite the first side 308). Cooler, dirty exhaust air is pushed out of the second channels of the ERV panel 300 via a fourth duct interface 322 of the ERV panel 300 (e.g., at the second side 320 of the housing 310, opposite the third duct interface 318), to ambient. In one embodiment, the fourth duct interface 322 is fluidly coupled to a further exhaust duct 324.

The second duct interface 316 is fluidly coupled and connected to the intake duct 302. The second duct interface 316 may be connected to the intake duct 302 in any number of ways including, for example, with an adhesive (e.g., tape), fasteners, other connectors, or any combination thereof. The third duct interface 318 is fluidly coupled and connected to the exhaust duct 304. The third duct interface 318 may be connected to the exhaust duct 304 in any number of ways including, for example, with an adhesive (e.g., tape), fasteners, other connectors, or any combination thereof. The second duct interface 316 and the third duct interface 318 may be removably connected to the intake duct 302 and the exhaust duct 304, respectively, such that a position of the ERV panel 300 relative to the intake duct 302 and the exhaust duct 304 may be changed.

The ERV panel 300 may be flipped when ambient temperature warms up and the building is to be cooled. The ERV panel 300 may be flipped, such that the first cover 306 faces towards the surface (e.g., the roof of the building) supporting the energy recovery ventilation panel 300, the intake duct 302, and the exhaust duct 304, and the second cover 312 faces in the direction towards the sun. In such a configuration, the second duct interface 316 is fluidly coupled and connected to the exhaust duct 304, and the third duct interface 318 is fluidly coupled and connected to the intake duct 302.

In such a configuration, warm or hot, fresh outside air is pulled into second channels within the ERV panel 300 via the fourth duct interface 322 of the ERV panel 300. Cooler, fresh outside air is pulled out of the second channels of the ERV panel 300 via the third duct interface 318 of the ERV panel 300, and into the intake duct 302. Cool and dirty exhaust air is pushed into the first channels within the ERV panel 300 via the second duct interface 316 of the ERV panel 300. Warmer, dirty exhaust air is pushed out of the first channels within the ERV panel 300 via the first duct interface 314 of the ERV panel 300, to ambient.

In one embodiment, a plurality of ERV panels 300 may be fluidly coupled and connected to the intake duct 302 and the exhaust duct 304. The plurality of ERV panels 300 may form, for example, an array of ERV panels 300.

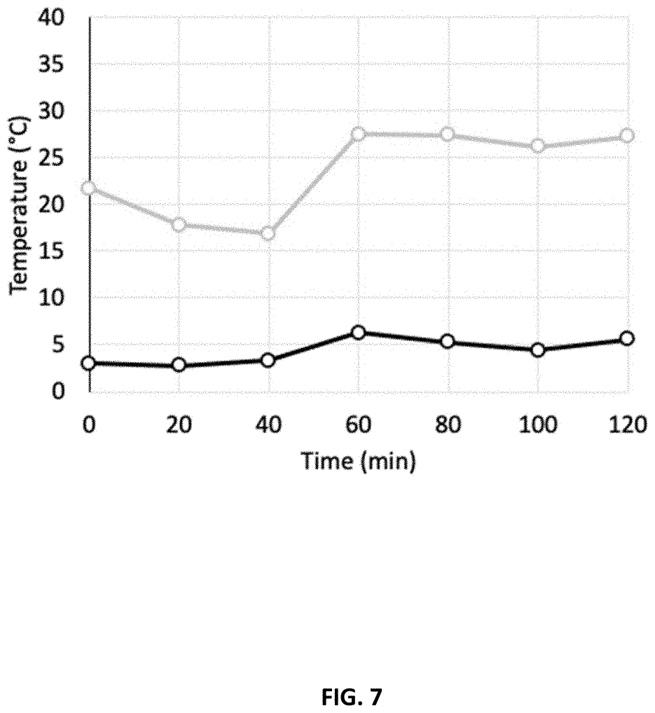

FIG. 7 is an exemplary plot of a temperature of clean air into a building after passing through an energy recovery ventilation panel of the present embodiments versus time. With time, the directness of sunlight changes, and thus, the solar energy transfer also changes. When in direct sunlight, for example, solar energy transfer may increase heat recovery efficiency above 200%, where standard efficiency without sunlight may be approximately 90%.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations and/or acts are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that any described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

1. An energy recovery ventilation device comprising:
a housing having a first side, a second side opposite the first side, a first end, and a second end opposite the second end, each of the first end and the second end extending between the first side and the second side of the housing;
at least one first channel within the housing, the at least one first channel extending between the first end and the second end of the housing;
at least one second channel within the housing, the at least one second channel extending between the first end and the second end of the housing, wherein a second channel of the at least one second channel is separated from a first channel of the at least one first channel by an inner wall of the housing;
a first inlet and a first outlet, the first inlet being fluidly coupled to the first outlet via the first channel;
a second inlet and a second outlet, the second inlet being fluidly coupled to the second outlet via the second channel;
a first cover supported by the first side of the housing, the first cover being made of a first material; and
a second cover supported by the second side of the housing, the second cover being made of a second material, the second material being different than the first material.

2. The energy recovery ventilation device of claim 1, wherein the first material is transparent to solar radiation and is a thermal insulator, and
wherein the second material is a reflective material, has a normal reflectance of at least 90%, or is a reflective material and has a normal emittance of at least 90%.

3. The energy recovery ventilation device of claim 2, wherein the first material is an acrylic, a polycarbonate, or a glass, and
wherein the second material is a metal foil, includes Silicon dioxide, boron nitride, barium sulfate, or any combination thereof, or is a metal foil and includes Silicon dioxide, boron nitride, barium sulfate, or any combination thereof.

4. The energy recovery ventilation device of claim 1, wherein the housing is a thermally conductive material.

5. The energy recovery ventilation device of claim 1, wherein a thickness of the inner wall of the housing is between 0.1 mm and 2.0 mm.

6. The energy recovery ventilation device of claim 5, wherein a thickness of the first channel, in a direction of the thickness of the inner wall of the housing, is between 2 mm and 100 mm, and
wherein a thickness of the second channel, in the direction of the thickness of the inner wall of the housing, is between 2 mm and 100 mm.

7. The energy recovery ventilation device of claim 6, wherein a height of the first channel, in a direction perpendicular to the direction of the thickness of the inner wall of the housing, is between 10 mm and 200 mm, and
wherein a height of the second channel, in the direction perpendicular to the direction of the thickness of the inner wall of the housing, is between 10 mm and 200 mm.

8. The energy recovery ventilation device of claim 1, wherein the first cover is removably attached to the first side of the housing, and the second cover is removably attached to the second side of the housing.

9. The energy recovery ventilation device of claim 1, wherein the first inlet comprises a first opening, the first opening extending from the second side of the housing, through the housing, and into the first channel, the first opening being adjacent to the first end of the housing,
wherein the first outlet comprises a second opening, the second opening extending from the first side of the housing, through the housing, and into the first channel, the second opening being adjacent to the second end of the housing,
wherein the second inlet comprises a third opening, the third opening extending from the second side of the housing, through the housing, and into the second channel, the third opening being adjacent to the second end of the housing, and
wherein the second outlet comprises a fourth opening, the fourth opening extending from the first side of the housing, through the housing, and into the second channel, the fourth opening being adjacent to the first end of the housing.

10. The energy recovery ventilation device of claim 9, wherein the energy recovery ventilation device is connectable to an air handling unit of a building, such that the first inlet is an intake air inlet, the first outlet is an intake air outlet, the second inlet is an exhaust air inlet, and the second outlet is an exhaust air outlet.

11. The energy recovery ventilation device of claim 9, wherein the inner wall is a first inner wall,
wherein another first channel of the at least one first channel is separated from the second channel by a second inner wall of the housing, the second inner wall of the housing being opposite the first inner wall of the housing, and
wherein another second channel of the at least one second channel is separated from the other first channel by a third inner wall of the housing, the third inner wall of the housing being opposite the second inner wall of the housing.

12. The energy recovery ventilation device of claim 11, further comprising:
a third inlet and a third outlet, the third inlet being fluidly coupled to the third outlet via the other first channel; and
a fourth inlet and a fourth outlet, the fourth inlet being fluidly coupled to the fourth outlet via the other second channel.

13. The energy recovery ventilation device of claim 12, wherein the third inlet comprises a fifth opening, the fifth opening extending from the second side of the housing, through the housing, and into the other first channel, the fifth opening being adjacent to the first opening,
wherein the third outlet comprises a sixth opening, the sixth opening extending from the first side of the housing, through the housing, and into the other first channel, the sixth opening being adjacent to the second opening,
wherein the fourth inlet comprises a seventh opening, the seventh opening extending from the second side of the housing, through the housing, and into the other second channel, the seventh opening being adjacent to the third opening, and
wherein the fourth outlet comprises an eighth opening, the eighth opening extending from the first side of the housing, through the housing, and into the other second channel, the eighth opening being adjacent to the third opening.

14. The energy recovery ventilation device of claim 9, further comprising:
a first inlet duct interface supported by the second side of the housing, adjacent to the first end of the housing;
a first outlet duct interface supported by the first side of the housing, adjacent to the second end of the housing;
a second inlet duct interface supported by the second side of the housing, adjacent to the second end of the housing; and
a second outlet duct interface supported by the first side of the housing, adjacent to the first end of the housing,
wherein the first inlet duct interface is fluidly coupled to the first outlet duct interface via the first opening, the first channel, and the second opening, and
wherein the second inlet duct interface is fluidly coupled to the second outlet duct interface via the third opening, the second channel, and the fourth opening.

15. The energy recovery ventilation device of claim 1, wherein the first cover and the second cover are rectangular in shape.

16. An energy recovery ventilation panel comprising:
a housing having a first side, a second side opposite the first side, a first end, and a second end opposite the second end, each of the first end and the second end extending between the first side and the second side of the housing;
a counterflow heat exchanger supported within the housing, the counterflow heat exchanger comprising a plurality of channels within the housing;
a first inlet duct interface supported by the first side of the housing, adjacent to the first end of the housing, and a first outlet duct interface supported by the first side of the housing, adjacent to the second end of the housing, wherein the first inlet duct interface is fluidly coupled to the first outlet duct interface via a first portion of channels of the plurality of channels;
a second inlet duct interface supported by the second side of the housing, adjacent to the second end of the housing, and a second outlet duct interface supported by the second side of the housing, adjacent to the first end of the housing, wherein the second inlet duct interface is fluidly coupled to the second outlet duct interface via a second portion of channels of the plurality of channels, the second portion of channels being different than the first portion of channels;
a first cover supported by the first side of the housing, the first cover being made of a first material; and
a second cover supported by the second side of the housing, the second cover being made of a second material,
wherein the first material is transparent to solar radiation and is a thermal insulator, and the second material is a reflective material, has a normal reflectance of at least 90%, or is a reflective material and has a normal emittance of at least 90%.

17. A waste heat recovery system comprising:
a plurality of energy recovery ventilation panels fluidly coupleable to an exhaust duct and an intake duct, each energy recovery ventilation panel of the plurality of energy recovery ventilation panels comprising:
a housing having a first side, a second side opposite the first side, a first end, and a second end opposite the second end, each of the first end and the second end extending between the first side and the second side of the housing;
a counterflow heat exchanger supported within the housing, the counterflow heat exchanger comprising channels extending between the first end and the second end within the housing;
a first duct interface and a second duct interface supported by the housing, the first duct interface being adjacent to the first end of the housing and the second duct interface being adjacent to the second end of the housing, the first duct interface being fluidly coupled to the second duct interface via a first portion of the channels;
a third duct interface and a fourth duct interface supported by the housing, the third duct interface being adjacent to the second end of the housing and the fourth duct interface being adjacent to the first end of the housing, the third duct interface being fluidly coupled to the fourth duct interface via a second portion of the channels, the second portion of the channels being different than the first portion of the channels;
a first cover supported by the first side of the housing, the first cover being made of a first material; and
a second cover supported by the second side of the housing, the second cover being made of a second material, the second material being different than the first material.

18. The waste heat recovery system of claim 17, wherein the plurality of energy recovery ventilation panels include an array of energy recovery ventilation panels fluidly coupleable to the exhaust duct and the intake duct.

19. The waste heat recovery system of claim 17, wherein the first material is transparent to solar radiation and is a thermal insulator, and
wherein the second material is a reflective material, has a normal emittance of at least 90%, or is a reflective material and has a normal emittance of at least 90%.

20. The waste heat recovery system of claim 17, wherein a position of the respective energy recovery ventilation panel relative to the exhaust duct and the intake duct is changeable, such that:
in a first configuration:
the first duct interface and the second duct interface are intake interfaces, and the first duct interface is fluidly coupled to the intake duct via the first portion of the channels and the second duct interface;
the third duct interface and the fourth duct interface are exhaust interfaces, and the fourth duct interface is fluidly coupled to the exhaust duct via the second portion of the channels and the third duct interface; and
the first cover faces a first direction; and
in a second configuration:
the third duct interface and the fourth duct interface are intake interfaces, and the fourth duct interface is fluidly coupled to the intake duct via the second portion of the channels and the third duct interface;
the first duct interface and the second duct interface are exhaust interfaces, and the first duct interface is fluidly coupled to the exhaust duct via the first portion of the channels and the second duct interface; and
the second cover faces the first direction.
